(19) United States
(12) Patent Application Publication
(10) Pub. No.: US 2025/0060015 A1
(43) Pub. Date: Feb. 20, 2025

(54) BRAKE ACTUATOR UNIT AND ELECTROMECHANICAL BRAKE

(71) Applicant: ZF Active Safety GmbH, Koblenz (DE)

(72) Inventor: Volker Knop, Ulmen (DE)

(21) Appl. No.: 18/806,005

(22) Filed: Aug. 15, 2024

(30) Foreign Application Priority Data
Aug. 16, 2023 (DE) 102023121911.1

(51) Int. Cl. F16D 65/18; F16D 55/226; F16D 121/24; F16D 125/50

(52) U.S. Cl. CPC F16D 65/18; F16D 55/226; F16D 2121/24; F16D 2125/50

(57) ABSTRACT

A brake actuator unit having a brake housing, a spindle, and an axial spindle bearing, which receives the spindle and absorbs the axial reaction forces of the spindle when the brake is applied. The brake housing has a brake calliper having a pad support portion and a pot-shaped brake piston bearing portion, which is integrally connected to the pad support portion and has a circumferential wall and a bottom. When the brake is operated, the spindle bearing is supported axially on the bottom, and the circumferential wall has a sliding guide face against which the brake piston bears. An electromechanical brake having such a brake actuator unit is also provided.

### CROSS-REFERENCE TO RELATED APPLICATIONS

This application claims priority to German Application No. 102023121911.1, filed on Aug. 16, 2023, the disclosure of which is incorporated herein by reference in its entirety.

### TECHNICAL FIELD

The disclosure relates to a brake actuator unit for an electromechanical disc brake, having a brake housing, a spindle, a brake piston, which is drive-coupled to the spindle and is axially movable by the spindle, and an axial spindle bearing, which receives the spindle and absorbs the axial reaction forces of the spindle when the brake is applied. The disclosure also relates to an electromechanical brake having such a brake actuator unit.

### BACKGROUND

In electromechanical brakes, an application force is brought about by a brake piston, by which an application force corresponding friction pads are brought into engagement with the brake disc. For this purpose, the electromechanical brake has a brake actuator unit. As the intensity of the application force increases, the phenomenon occurs of shifting of the force application point on the brake disc or friction pads. As a result of the elasticity of the brake housing of the brake and the compressing friction pads, the force application point of the application force shifts in a radial direction. The force application point likewise shifts in a tangential direction relative to the rotational movement of the brake disc. As a result, the force application point of the reaction forces that are brought about by the application force and are absorbed by the brake housing therefore shifts by an equal amount. The drive that brings about the linear displacement of the brake piston can thereby become unstable in terms of its orientation and mounting. In other words, as a result of eccentric force components of the reaction forces, angular offsets occur between individual components of the drive. This causes increased and non-uniform wear and a sub-optimal force geometry so that the application forces brought about are adversely affected.

Furthermore, forced oscillations of the electromechanical brake resulting from vibrations at the vehicle axle have a disadvantageous effect on the effectiveness and wear.

There is therefore a need to provide a more robust brake actuator unit in order to overcome or at least reduce the disadvantages of the prior art.

### SUMMARY

Exemplary arrangements of the disclosure are set forth in the independent claims. Other exemplary arrangements are specified in the dependent claims and the following description, each of which can represent aspects of the disclosure by themselves or in (sub-) combination. Some aspects are explained with regard to different devices. However, the features are interchangeable.

According to one aspect, a brake actuator unit for an electromechanical disc brake has a brake housing, a spindle, a brake piston, which is drive-coupled to the spindle and is axially movable by the spindle, and an axial spindle bearing, which receives the spindle and absorbs the axial reaction forces of the spindle when the brake is applied. The brake housing also has a brake calliper having a pad support portion and a pot-shaped brake piston bearing portion, which is integrally connected to the pad support portion and has an axially extending circumferential wall and a bottom, which extends radially inwards from the circumferential wall and through which the spindle runs. When the brake is operated, the spindle bearing is supported axially on the bottom, and the circumferential wall forms, on its radial inner side, a sliding guide face for the brake piston so that the brake piston bears at least in some portions against the inner side.

The brake actuator unit designed in this way advantageously allows eccentric force components to be compensated. The sliding guide face on the radial inner side of the circumferential wall allows a restoring force to be brought about in the direction of the rotational axis of the spindle. As a result, the orientation and mounting of the individual components of the brake actuator unit can be improved, for example the symmetry in relation to the rotational axis of the spindle. Overall, this results in an improved force loading of the brake piston and reduced wear.

Because the brake piston bearing portion forms an integral part of the brake housing together with the circumferential wall, the brake actuator unit is robust, and therefore forces acting on the brake actuator unit when the brake is operated, as well as vibrations, can be absorbed or dissipated particularly effectively.

The brake housing can be designed as a single piece in order to improve the structural integrity of the brake actuator unit further and effectively suppress oscillations.

According to one exemplary aspect, the brake actuator unit has a gear module, which is drive-coupled to the spindle and has a gear housing that is fastened directly to the brake calliper. The forces acting on the brake actuator unit when the brake is operated can thereby be directed into the brake calliper and from there into the body of the vehicle.

The gear housing can be an outer housing of the gear module, as a result of which the brake actuator unit can be compact.

Additionally, or alternatively, the gear housing can be designed as a single piece in order to increase robustness.

According to a further aspect, the gear housing has a centring hole, which runs coaxially with a centring collar of the brake calliper and is connected thereto. In this way, centring of the spindle can be effectively ensured, and therefore eccentric force components can be reduced.

It can also be provided for the gear module to have a ring gear, which is mounted by a press fit in a receptacle in the gear housing. The ring gear is part of a gearing mechanism that is drive-connected to the spindle. The gear module is compact and robust due to this design.

In one exemplary arrangement, the gear housing is designed such that all the torques applied by an electric motor and by the gearing mechanism are directed via the gear housing directly into the brake calliper. Therefore, the path via which the torques are directed into the brake calliper and from there into the body of the vehicle is short.

According to the disclosure, an electromechanical brake is also provided, having an electric motor for operating the brake, which motor is torque-transmittingly coupled to the spindle, and having a brake actuator unit according to the disclosure with the aforementioned advantages.

### BRIEF DESCRIPTION OF THE DRAWINGS

Further advantages and features of the disclosure can be found in the description below and in the attached drawings. In the figures:

FIG. 1 shows an exploded diagram of an electromechanical brake according to the disclosure with a brake actuator unit according to the disclosure,

FIG. 2 shows a longitudinal sectional view of the brake of FIG. 1,

FIG. 3 shows an exploded diagram of an electromechanical operating unit of the brake of FIG. 1 with a gear module, and

FIG. 4 shows an exploded diagram of the gear module of FIG. 3.

### DETAILED DESCRIPTION

The following detailed description in conjunction with the attached drawings, in which the same numerals refer to the same elements, is intended as a description of different exemplary arrangements of the disclosed subject matter and is not intended to represent the individual arrangements. Each exemplary arrangement described in this disclosure serves only as an example or illustration and should not be interpreted as preferred or advantageous over other arrangements.

All the features disclosed below in relation to the exemplary arrangements and/or the accompanying figures can be combined alone or in any sub-combination with features of the aspects of the present disclosure, including features of preferred exemplary arrangements, provided that the resulting combination of features is reasonable to a person skilled in the technical field.

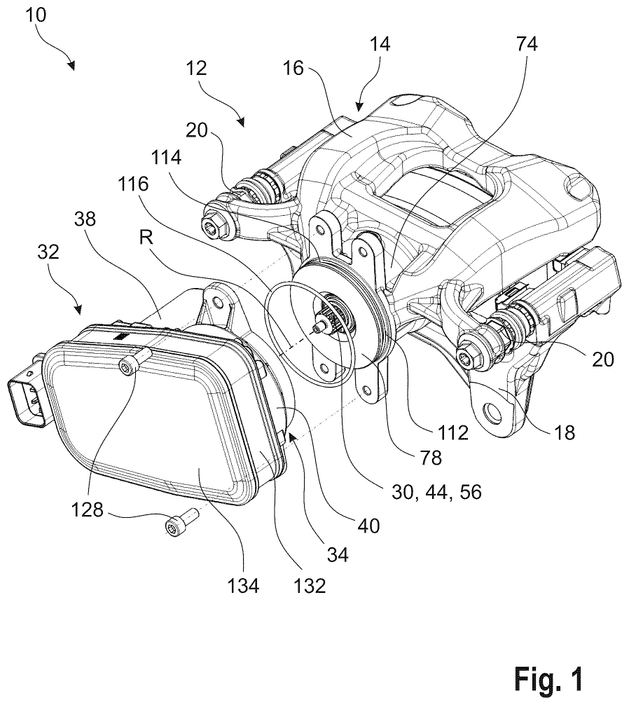

FIG. 1 shows an electromechanical brake 10 having a brake actuator unit 12.

In this case, the electromechanical brake 10 is a disc brake for a vehicle and is assigned to a wheel of the vehicle.

The brake actuator unit 12 has a brake housing 14 with a brake calliper 16 and a base support 18 by which the brake 10 is fastened to the body of the vehicle.

In this connection, the brake calliper 16 is connected to the base support 18 via linear guides 20 and is movable via these in the axial direction relative to the base support 18 and is thus mounted floatingly.

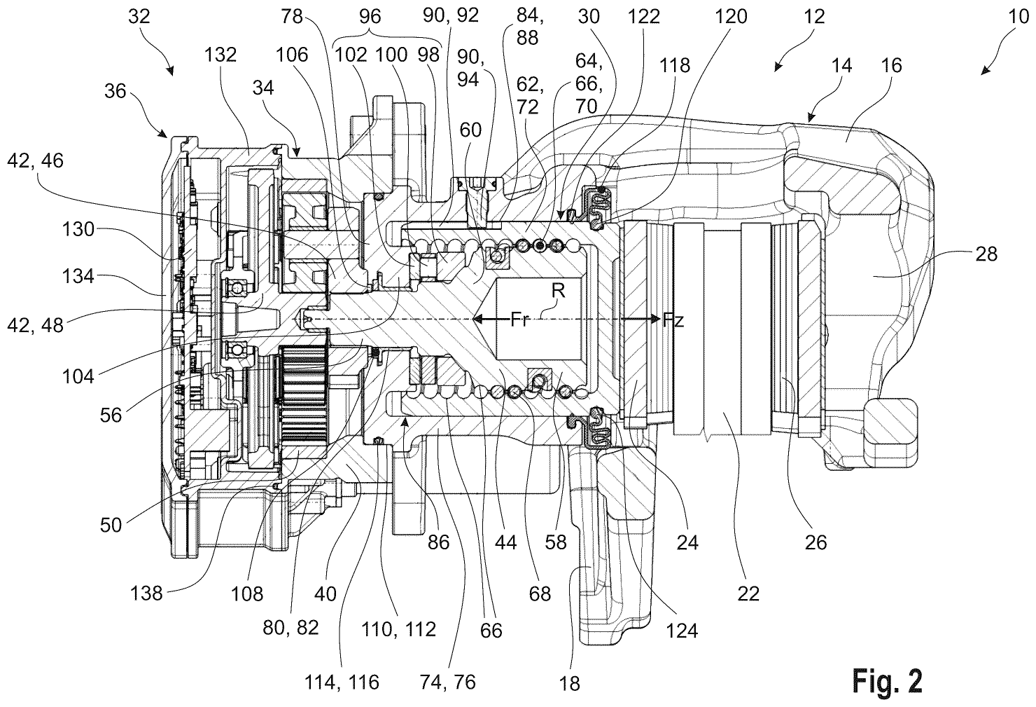

The brake calliper 16 surrounds a brake disc 22 (see FIG. 2), for example, a brake disc rotor, which can be clamped by being held in the axial direction by two brake pads 24, 26.

The inner brake pad 24 in the axial direction is mounted on the base support 18 displaceably in the axial direction.

The outer brake pad 26 in the axial direction is attached to a pad support portion 28, which is an integral part of the brake calliper 16.

The inner brake pad 24 along a rotational axis R of the brake actuator unit 12 is actively loaded with an application force Fz by the brake actuator unit 12 when the brake 10 is activated.

In the present case (in the ideal case of compensated transverse forces), the rotational axis R of the brake actuator unit 12 also corresponds to the cylinder axis of the brake housing 14 and to the brake disc rotational axis of the brake disc 22.

The axially displaceable brake calliper 16 ensures that the outer brake pad 26 in the axial direction is likewise loaded with the application force Fz. In the process, the application force Fz is distributed substantially uniformly in terms of amount to the inner brake pad 24 and the outer brake pad 26. A friction fit with the brake disc 22 can thus be ensured for both brake pads 24, 26 as a result of the provided pressure force, which friction fit is used to decelerate or park the vehicle.

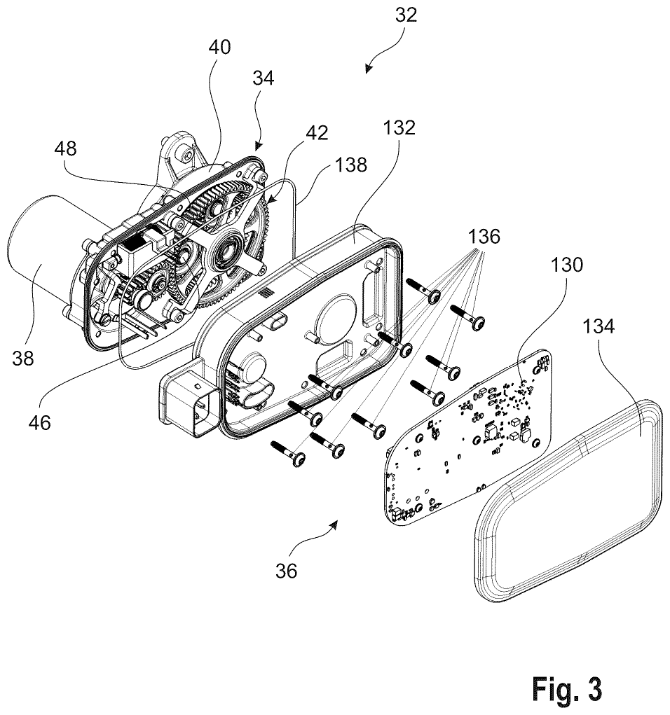

The brake actuator unit 12 also has an actuation device 30 and an electromechanical operating unit 32 (see FIG. 3) having a gear module 34 and an electronic module 36.

The actuation device 30 and the gear module 34 are designed to generate the application force Fz together with an electric motor 38.

The electromechanical operating unit 32 forms, together with the electric motor 38, a closed sub-assembly that can be installed separately.

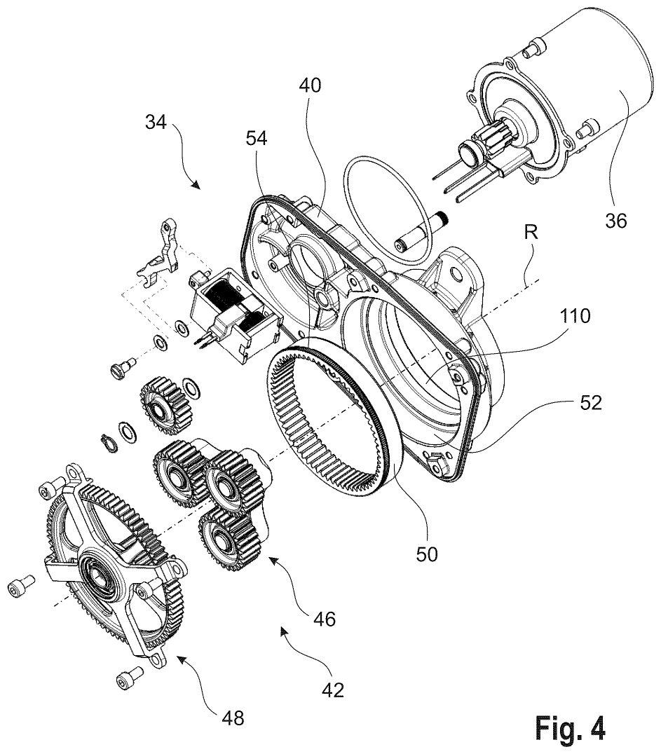

The gear module 34 has a gear housing 40 and a gearing mechanism 42 (see FIG. 4), which is fastened to the gear housing 40 or mounted in the gear housing 40 and drive-connects the electric motor 38 to a spindle 44 of the actuation device 30.

In the present case, the gear housing 40 is designed as a single piece and forms an outer housing of the gear module 34.

The gear housing 40 can also be formed from plastic, for example a fibre-reinforced plastic, or a lightweight metal, for example an aluminium alloy.

In this case, the gearing mechanism 42 is a multi-stage reduction gearing mechanism and comprises a three-gear stage 46 and a planetary gear stage 48 with a ring gear 50.

The ring gear 50 is manufactured from metal, for example, sintered metal.

In the present exemplary arrangement, the ring gear 50 is arranged in a cylindrical receptacle 52 (see FIG. 4) of the gear housing 40 and fastened to the gear housing 40 by a press fit with interference and a knurled connection.

To form the knurled connection, the ring gear 50 has a knurled outer circumferential portion 54.

In an alternative exemplary arrangement, the gear housing 40 is injection-moulded around the ring gear 50 and is then manufactured from plastic.

The clearance-free press fit between the ring gear 50 and the receptacle 52 ensures effective centring and orientation of the ring gear 50 with the gear housing 40.

Furthermore, the knurled connection ensures effective securing against rotation of the ring gear 50 in the gear housing 40 by means of a form fit, for example even at high temperatures.

In the present exemplary arrangement, the gearing mechanism 42 (see FIG. 1) is torque-transmittingly coupled to the actuation device 30 via a drive shaft extension 56, which is arranged at an axial end of the spindle 44.

The spindle 44 also has a shaft portion 58 on the brake pad side and a transition portion 60, which is arranged between the drive shaft extension 56 and the shaft portion 58 along the rotational axis R of the spindle 44. The outer diameter of the drive shaft extension 56 of the brake actuator unit 12 is smaller in the radial direction than the outer diameter of the shaft portion 58 in this direction. Correspondingly, the spindle 44 narrows in terms of its outer diameter in the region of the transition portion 60.

The actuation device 30 also has a spindle nut 62, which is secured against rotation, and a spindle drive 64, which in the present case is designed as a ball screw spindle without self-locking. The spindle drive 64 comprises a thread 66, in which balls 68 are arranged and roll. The spindle 44 and the spindle nut 62 have mutually corresponding race parts, which together form the thread 66. Along the ball races 70 of the thread 66, the balls 68 can allow a translational movement of the spindle nut 62 along the rotational axis R relative to the spindle 44. For this purpose, the ball races 70 are formed at least partially in the shaft portion 58 of the spindle 44 and the spindle nut 62.

The diameter of the ball races 70 corresponds to the diameter of the balls 68, taking into account manufacturing tolerances and necessary gap widths.

In the present exemplary arrangement, the spindle nut 62 forms a brake piston 72 of the brake actuator unit 12.

In an alternative exemplary arrangement, the brake piston 72 and the spindle nut 62 are separate components that are drive-coupled to one another.

As a result of the translational movement of the spindle nut 62 in the direction of the brake disc 22, the spindle nut 62 or the brake piston 72 is moved in the direction of the inner brake pad 24 and thus ensures the active loading of the inner brake pad 24 with the application force Fz.

The rotation of the spindle 44 is ensured by the electric motor 38, which is in engagement with the drive shaft extension 56 of the spindle 44 via the gearing mechanism 42. The pitches of the spindle drive 64, for example of the ball races 70, and the blocking of a rotational movement of the spindle nut 62 then mean that the rotation of the spindle 44 causes a translational movement of the spindle nut 62. This movement is transmitted via the spindle nut 62 or the brake piston 72 to the brake pads 24, 26.

The generated application force Fz is proportional to the torque that is caused at the drive shaft extension 56 by the electric motor 38 and the gearing mechanism 42.

In this connection, the brake calliper 16 has a pot-shaped brake piston bearing portion 74 with a circumferential wall 76 extending along the rotational axis R and a bottom 78 extending radially from the circumferential wall 76 towards the rotational axis R. The open end of the pot-shaped brake piston bearing portion 74 is arranged on the brake pad side along the rotational axis R. This means that the bottom 78 is arranged on the end of the brake piston bearing portion 74 opposite the brake disc 22. The bottom 78 has a through-hole 80 for the drive shaft extension 56 of the spindle 44, which drive shaft extension is held therein by a radial bearing 82.

The brake calliper 16 is designed as a single piece in the present exemplary arrangement.

In principle, the brake calliper 16 can be formed from multiple individual parts, but the brake piston bearing portion 74 is connected integrally to the pad support portion 28 in all the exemplary arrangements.

The bottom 78 and the circumferential wall 76, more precisely the radial inner side 84 of the circumferential wall 76, delimit a cylindrical receptacle 86 in which at least some portions of the spindle 44 and the spindle nut 62 or the brake piston 72 are arranged. The linear displaceability of the spindle nut 62 or the brake piston 72 means that these components can also be arranged at least partially outside the cylindrical receptacle 86.

In this case, the inner side 84 forms a sliding guide face 88 for the spindle nut 62 or the brake piston 72, against which face the spindle nut 62 or the brake piston 72 bears, at least in some portions, and is guided axially thereby.

The spindle nut 62 is guided linearly and secured against rotation inside the cylindrical receptacle 86 relative to the brake piston bearing portion 74, as already mentioned, by an anti-rotation lock 90.

For this purpose, the spindle nut 62 has on the outer circumference an axial groove 92, which is in engagement with a dog 94, which protrudes radially from the inner side 84 of the circumferential wall 76 into the cylindrical receptacle 86 in order to form the anti-rotation lock 90.

In the exemplary arrangement shown, the dog 94 is formed by a screw that extends in the radial direction through the circumferential wall 76.

This anti-rotation lock 90 is necessary mainly when the contact between the spindle nut 62 or the brake piston 72 and a support of the inner brake pad 24 is not established. When contact is established between the spindle nut 62 or the brake piston 72 and the support of the inner brake pad 24 or the support thereof, the application force Fz generates a frictional torque that secures the spindle nut 62 against rotation.

The generated application force Fz is proportional to the axial travel distance of the spindle nut 62. The proportionality factor corresponds to the instantaneous system stiffness. The friction pad wear is also compensated by the axial travel of the spindle nut 62.

As a result of the generated application force Fz, a reaction force Fr opposing the application force Fz occurs along the rotational axis R. Owing to the elastic expansion of the components of the brake 10, an angular offset can generally occur between the brake disc rotational axis and the cylinder axis of the brake housing 14, so that the reaction force Fr has eccentric force components. These eccentric force components can result in an instability of the components of the brake actuator unit 12 in the radial direction, when the core diameter of the spindle drive 64 is smaller than the outer diameter of a bearing intended to absorb the reaction force Fr.

For this reason, the brake actuator unit 12 in the present case comprises a rotationally symmetrical spindle bearing 96 in the form of an axial bearing (see FIG. 2) with a bearing ring 98 that has a spherical bearing contact face on the brake pad side. The spindle bearing 96 is in contact with the conical transition portion 60 of the spindle 44, which portion has a contact face complementary to the spherical bearing contact face.

The bearing ring 98 also has a planar contact face, which is arranged opposite the spherical bearing contact face along the rotational axis R.

The brake actuator unit 12 also has rolling elements 100, which are in contact with the bearing ring 98 via the more planar contact face.

A bearing disc 102 is additionally arranged between the rolling elements 100 and the bottom 78 of the brake piston bearing portion 74, which bearing disc has opposing planar contact faces along the rotational axis R and is pressed into the bottom 78 in a manner secured against rotation by a friction fit and/or form fit. One of the contact faces of the bearing disc 102 is in contact with the bottom 78. The rolling elements 100 roll on the other of the two contact faces of the bearing disc 102.

The reaction force Fr occurring is thus transmitted from the spindle 44 via the transition portion 60 to the spherical bearing contact face of the spindle bearing 96, and from there is absorbed via the rolling elements 100 and the bearing disc 102 by the bottom 78 of the brake piston bearing portion 74. In other words, the axial reaction force Fr of the spindle 44 is directed via the spindle bearing 96 into the bottom 78 when the brake 10 is applied.

In an alternative exemplary arrangement, the spindle bearing 96 in the form of an axial bearing can in principle be designed in any desired way.

In this connection, the bottom 78 has an axial, protruding, annular pedestal 104, which protrudes axially into the cylindrical receptacle 86, spaced by an interstice from the inner side 84 of the circumferential wall 76. The spindle bearing 96 in the initial position can thereby be arranged in an inner bore of the spindle nut 62, as a result of which a reduction in the axial length of the actuation device 30 is achieved.

In this case, some portions of the spindle nut 62 can protrude axially into the interstice between the axial pedestal 104 and the inner side 84 of the circumferential wall 76.

The drive shaft extension 56 of the spindle 44 is supported radially by the radial bearing 82.

The radial bearing 82 has a collar, which acts as an axial stop or one-sided axial bearing and is supported by the outer wall of the bottom 78 opposite the cylindrical receptacle 86.

The radial bearing 82 advantageously consists of plastic, as a result of which stop damping can be provided to reduce noise.

The brake actuator unit 12 also has a package, including a securing ring 106 snapped into a groove in the spindle 44 and of a fit ring 108 that transmits one-sided axial forces from the spindle 44 to the collar of the radial bearing 82. The package prevents a one-sided translational movement of the spindle 44 in the direction of the spindle nut 62. In addition, the securing ring 106 positions the gearing mechanism 42 on the spindle 44 on one side in the axial direction.

In order to centre the gearing mechanism 42 relative to the brake piston bearing portion 74, the gear housing 40 has a centring hole 110, which is form-fittingly connected to a centring collar 112 of the brake calliper 16.

The centring hole 110 and the centring collar 112 extend in the axial direction and are oriented coaxially with one another and with the rotational axis R.

In the present exemplary arrangement, the centring collar 112 is arranged on the outer circumference of the brake piston bearing portion 74.

In principle, the centring collar 112 can be fastened to the brake calliper 16 at any location, for example on any outer circumference.

The centring collar 112 has a circumferential groove 114 in which a seal 116 is arranged. The seal 116 seals the gear housing 40 statically against the brake calliper 16 and thus prevents the ingress of moisture and foreign particles from the environment into the brake actuator unit 12.

In this connection, the brake actuator unit 12 has a bellows 118, which prevents the ingress of moisture and foreign particles from the environment into the spindle drive 64 over the entire travel distance of the spindle nut 62. For this purpose, the bellows 118 has two cylindrical seal beads 120, 122 on its opposite ends. An inner seal bead 120 is held with preloading in a circumferential outer groove 124 on the spindle nut 62. The outer seal bead 122 is held in a circumferential inner groove in the inner side 84 of the circumferential wall 76 and seals dynamically against the outer diameter of the spindle nut 62.

The gear housing 40 is fixed directly to the brake calliper 16 in the axial and tangential directions by a form fit and a friction fit via at least two preloaded threaded screws 128.

Via this screw connection, all the reaction forces and reaction torques generated by the electric motor 38 and by the gearing mechanism 42 during generation of a drive torque on the spindle 44 are transmitted from the gear housing 40 directly to the brake calliper 16.

The gear housing 40 also supports all the reaction forces and reaction torques that arise during the action of vibrations and directs these onwards to the brake calliper 16.

The gear housing 40 is then in force and torque equilibrium with the brake calliper 16.

The screw connection between the gear housing 40 and the brake calliper 16 also ensures securing against rotation and axial fixing of the gear module 34 on the brake calliper 16.

To control the electric motor 38, the electronic module 36 has a circuit board 130, which is connected signal-transmittingly to the electric motor 38.

The circuit board 130 is arranged in an electronics housing 132 of the electronic module 36, which is closed in a leakproof manner by a cover 134.

The electronic module 36 is fastened to the gear housing 40 via the electronics housing 132 by connection screws 136 and is connected in a leakproof manner to the gear module 34 by a packing cord 138, for example.

The electronics housing 132 forms a type of cover or cap for the gear housing 40.

In this way, a brake actuator unit 12 and an electromechanical brake 10 having a brake actuator unit 12 that are robust are provided.

In brake actuator units known from the prior art, the reaction forces and reaction torques are directed indirectly from a skeleton-like frame, which is screw-fastened to a gear housing, to the brake housing and a separate sleeve. This results in disadvantages not only in relation to cost but also in relation to vibrations. The skeleton-like frame, with all the components attached to it, constitutes an oscillator with low damping within the brake actuator unit, which oscillator is excited to oscillation amplitudes as a result of the vibrations at the vehicle axle. The oscillation amplitudes cause high stresses in the skeleton-like frame and in particular in the gear housing.

In contrast to this, the direct fixing of the gear housing 40, with all the components attached to it, on the single-part brake calliper 16, as described above, reliably ensures the integrity of the brake actuator unit 12, for example when vibrations act on the vehicle axle on driving over a poor road surface. In this connection, the gear module 34 can be regarded as a resonator, which is excited to forced oscillations by an excitation force. The accelerations arising during vibrations act on the centre of gravity of the gear module 34 and can generate a periodically changing acceleration force, which acts as an excitation force on the resonator. The resonator then oscillates at the frequency of the excitation force. The greater the damping and stiffness of the resonator, the smaller the vibration amplitude thereof. The direct screw attachment of the gear module 34 to the brake calliper 16 via the single-piece gear housing 40 ensures high damping and high stiffness of the resonator.

The structure of the brake actuator unit 12 also ensures that eccentric force components are compensated when the brake 10 is operated.

Furthermore, the brake actuator unit 12 is compact.

1. A brake actuator unit for an electromechanical disc brake, comprising a brake housing, a spindle, a brake piston, which is drive-coupled to the spindle and is axially movable by the spindle, and an axial spindle bearing, which receives the spindle and absorbs the axial reaction forces of the spindle when the brake is applied, wherein the brake housing has a brake calliper having a pad support portion and a pot-shaped brake piston bearing portion, which is integrally connected to the pad support portion and has an axially extending circumferential wall and a bottom, which extends radially inwards from the circumferential wall and through which the spindle runs, wherein, when the brake is operated, the spindle bearing is supported axially on the bottom, and the circumferential wall forms, on its radial inner side, a sliding guide face for the brake piston so that the brake piston bears at least in some portions against the inner side.

2. The brake actuator unit according to claim 1, wherein that the brake housing is designed as a single piece.

3. The brake actuator unit according to claim 1, wherein the brake actuator unit has a gear module, which is drive-coupled to the spindle and has a gear housing that is fastened directly to the brake calliper.

4. The brake actuator unit according to claim 3, wherein the gear housing is an outer housing of the gear module.

5. The brake actuator unit according to claim 3, wherein the gear housing is designed as a single piece.

6. The brake actuator unit according to claim 3, wherein the gear housing has a centring hole, which runs coaxially with a centring collar of the brake calliper and is connected thereto.

7. The brake actuator unit according to claim 3, wherein the gear module has a ring gear, which is mounted by a press fit in a receptacle in the gear housing, wherein the ring gear is part of a gearing mechanism that is drive-connected to the spindle.

8. The brake actuator unit according to claim 3, wherein the gear housing is designed such that all the torques applied by an electric motor and by the gearing mechanism are directed via the gear housing directly into the brake calliper.

9. An electromechanical brake having an electric motor for operating the brake, which motor is torque-transmittingly coupled to the spindle, and having a brake actuator unit according to claim 1.

10. The brake actuator unit according to claim 2, wherein the brake actuator unit has a gear module, which is drive-coupled to the spindle and has a gear housing that is fastened directly to the brake calliper.

11. The brake actuator unit according to claim 4, wherein the gear housing is designed as a single piece.

12. The brake actuator unit according to claim 5, wherein the gear housing has a centring hole, which runs coaxially with a centring collar of the brake calliper and is connected thereto.

13. The brake actuator unit according to claim 6, wherein the gear module has a ring gear, which is mounted by a press fit in a receptacle in the gear housing, wherein the ring gear is part of a gearing mechanism that is drive-connected to the spindle.

14. The brake actuator unit according to claim 7, wherein the gear housing is designed such that all the torques applied by an electric motor and by the gearing mechanism are directed via the gear housing directly into the brake calliper.
